(19) United States
(12) Patent Application Publication
(10) Pub. No.: US 2010/0242860 A1
(43) Pub. Date: Sep. 30, 2010

(54) Pet Information Wallet

(76) Inventor: Brett Tyler Chaffin, Dillon, CO (US)

Correspondence Address: BRETT CHAFFIN, 353 BULLION MINE RD., DILLON, CO, 80435, US

(21) Appl. No.: 11/676,923

(22) Filed: Feb. 20, 2007

(51) Int. Cl. A01K 27/00; G09F 3/00; G09F 3/20

(52) U.S. Cl. 119/858; 40/303; 40/649

(57) ABSTRACT

The pet identification wallet is a non-rigid wallet designed to wrap around a pet's collar. The wallet has a large buttonhole in it, allowing the metal “D” ring on the collar to pass thru the wallet for external leash or lanyard attachment. The identification wallet allows for the lengthy and detailed amounts of owner and pet information required in today's information society. The industry standard metal pet tags/licenses, which are usually required by law to be affixed to the collar's “D” ring, wrap up and become encapsulated inside the wallet keeping them from falling off, wearing out, and making noise. The outside of the wallet has a clear plastic sleeve and/or name placard where reflective material having the pet's name printed on it is slid inside the clear outer sleeve or affixed, making the pet easily identifiable and safer at night.

### 1. FIELD OF THE INVENTION

The present invention relates to pet safety. In today's information society the “industry standard” small metal pet I.D. tags only allow for a maximum of 3 to 4 lines of text for information. Today, families have multiple phone numbers, vacation homes, and pets on life critical medications, to name just a few situations. Something that can travel with the pet which can handle the vast amounts of information needed to keep a pet safe and get him returned to his owner(s) needed to be invented.

### 2. BACKGROUND OF THE INVENTION

In a complex world of home phones, work phones, multiple cellular phones for multiple members of one family, main houses, vacation houses, pets which travel between multiple household in divorced families, pets being brought on vacation, and the advancement of veterinarian medicine which can have pets in life critical medical situations, more information is needed to accompany today's pets to keep them safe and identifiable. The pet wallet allows for a large amount of information to be printed inside the wallet. Additionally the information is printed in a size that is 5 to 10 times the size of the largest text available on a metal engraved disk. As our population ages and eyesight is not as acute as it once was, the large bold text is a welcome alternative to the less visible smaller text on a metal disk.

In addition to increased information, keeping the pet's license tags, which are usually required pursuant to most state, county, and or local jurisdictions, affixed in a safer manner to the dog's collar is an added feature. The metal license disks supplied by most jurisdictions are required to be affixed by a metal fastening device with hand tools directly to the pet's collar. The fastening devices can get bent and caught on things that the pet comes in contact with at any given time, causing the metal I.D. tags and licenses to fall off the pet, leaving him without any means of identification. Wrapping the metal pet information inside the pet wallet keeps them protected and safe.

The additional benefit is that when the metal tags are wrapped up inside the wallet, they do not rub against each other, which can cause them to become unreadable, and they do not make noise. Silencing the metal tags gives both a benefit to the owner and the pet. A human has a hearing frequency range of 64-23,000 Hz. A dog, for example, has a hearing frequency of 67-45,000 Hz, almost double that of a human being, and a cat's hearing frequency range is 45-64,000 Hz, almost triple that of a human being. Noises that occur from man, animal or nature on a daily basis can be completely inaudible to humans but will awaken and alert our household pets. Pet's moving about the house causing the metal tags and licenses to make noise can wake up adults, children even other household pets in the middle of the night. By silencing the tags, the pet also does not have to listen to unnecessary and annoying sounds in its own ears.

Additionally, when the traditional pet “nametag” is left dangling from the pet's collar it will eventually chaff and wear out, becoming difficult to read. The pet wallet allows for a large personalized pet nametag to be affixed on the outside of the wallet so that the pet's name is highly visible and easily readable. The large exterior nametag is also made of highly reflective material, which will help keep the dog visible at night.

It should not be forgotten that on hunting expeditions and in pet shows, licensing tags are removed from the pet to prevent undesired noises. Should a pet get away from the owner in such an environment, the owner is faced with the pet having no information to return the pet to the owner, as well as possibly incurring fines from government agencies for a pet detained without the proper licenses.

Also, others have appreciated the desirability of having pet tag information holders. For example Dettmann et al., U.S. Pat. No. 4,137,660 is a pet collar with limited information that can be written on the collar but suffers from various deficiencies, such as the information cannot meet the needs of the information superhighway generation and cannot be altered or replaced without changing the collar, nor does it add the element of safety with reflectivity.

The noise associated with pet collars has also been acknowledged but not adequately addressed. For example, Schiable, U.S. Pat. No. 6,367,426 and McConnell, U.S. Pat. No. 4,259,798 disclosed tag holders which suffer from various deficiencies, including the fact that said tag holders leave the metal tags hanging off the pets collar and do not keep the metal tags, nor their product from getting caught and pulled off by things that a pet many come in contact with at any given time such as tree limbs, sticks, fences, etc.

U.S. Pat. No. 7,168,394 issued Jan. 30, 2007 to W. Berry, describes an ornamental slipcover for dogs. A fabric sleeve designed to slide onto the collar. It is an ornamental apparel, and in particular, a slipcover for dog collars for the purpose of decorating the collar with a fabric cover that slides onto and off the collar. It addresses the widespread fondness for personal pet attire and appearance but does not address the need for increased information, stopping metal pet tag noise, nor the safety of the animal.

U.S. Pat. No. 2,342,005 issued Feb. 15, 1944 shows that Americans have long been concerned with personal safety at night. Since pets have grown with our society to become members of the family we to extrapolate ways to give our pets the same safety considerations we give humans.

### SUMMARY OF THE INVENTION

The pet information wallet, which holds retrieval information as well as quiets metal tags and licenses, has a nighttime safety feature, and a highly visible exterior nametag. It is a completely unique product in the pet universe. The household pet has come to the forefront of our society as a member of the family. Increased information needs have caused a need to address the issue of the inadequacies of the industry standard metal pet I.D. tags. The pet information wallet allows for vast and detailed information about both the owner and the pet. In addition to the enhanced information, the wallet also serves many other functions. Allowing the existing metal I.D. tags and licenses to be wrapped up and encapsulated inside the wallet keeps the metal tags from falling off, rubbing against each other and wearing out, as well as not making noise, which is bothersome to both the owners and the pets. A large, highly visible reflective exterior nametag makes the pet easily identifiable and safe at night. Finally, having a buttonhole thru the wallet allows the collars metal “D” ring to protrude thru the wallet maintaining the collars full functionality in its ability to attach to a leash or lanyard.

### BRIEF DESCRIPTION OF THE DRAWINGS

FIG. 1 is a perspective view of one embodiment of the present pet wallet invention, showing the outside of the pet information wallet in the open position.

FIG. 2 is a perspective view of another embodiment of the present invention showing the inside of the pet information wallet in the open position.

FIG. 3 is a perspective view of the interchangeable reflective nametag, which slides into the outside sleeve of the wallet displaying the pet's name or placard.

FIG. 4 is a perspective view of another embodiment of the present invention showing the inside of the pet information wallet, a collar and metal tags are being shown in phantom disposed inside of the pet wallet.

FIG. 5 is an illustration of the pet information wallet as seen from inside the collar with the wallet affixed to the pet's collar. A pet collar is being shown in phantom.

FIG. 6 is an illustration of the pet information wallet as seen from the outside of the collar with the wallet affixed to the pet's collar. A pet collar is being shown in phantom.

FIG. 7 is an illustration of the pet information wallet on a pet. A pet collar and dog are being shown in phantom.

FIG. 8 is an illustration of the pet information wallet on a pet. A pet collar, a dog, and a leash are shown in phantom

### DETAILED DESCRIPTION OF THE PREFERRED EMBODIMENTS

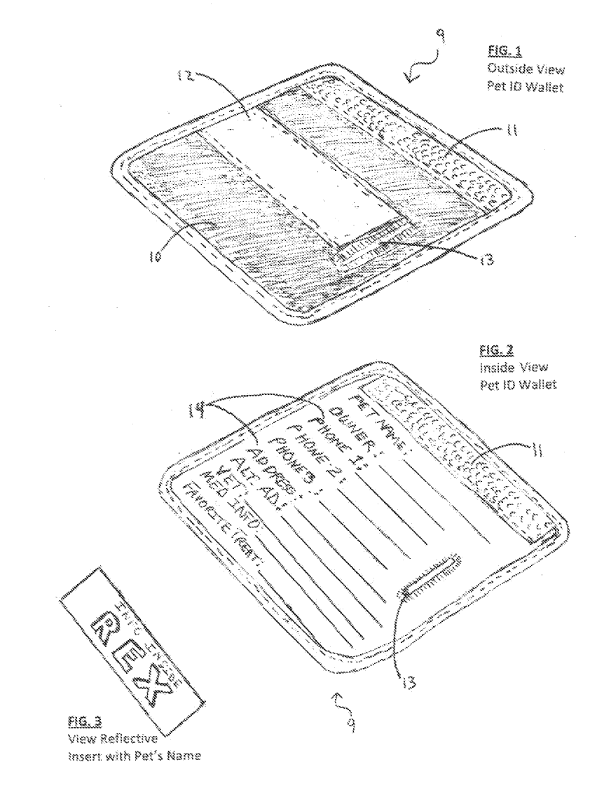

The present invention is an information wallet for pets, designed generally as 9 in the drawings and sized accordingly to fit all variations of pet collars available on the market. Referring first to FIG. 1 the exterior or outside of the pet wallet is constructed of a water resistant non rigid and or stretchable fabric 10 having one of various attachment means including, but not limited to, hook and loop fasteners, snaps, rivets, glue, buttons, etc., attached to one end 11 and a clear see-thru sleeve centered and attached to the outside 12 which is open on one end to allow the insertion of but not limited to, placards, name cards, tags, etc., and allow for moisture removal. A button hole type opening 13 to allow the permanently affixed metal “D” ring 27, which comes standard on pet collars, encapsulating the existing metal pet I.D. tags and licenses and still allows the attachment of a leash or lanyard while the pet information wallet remains affixed to the pet's collar.

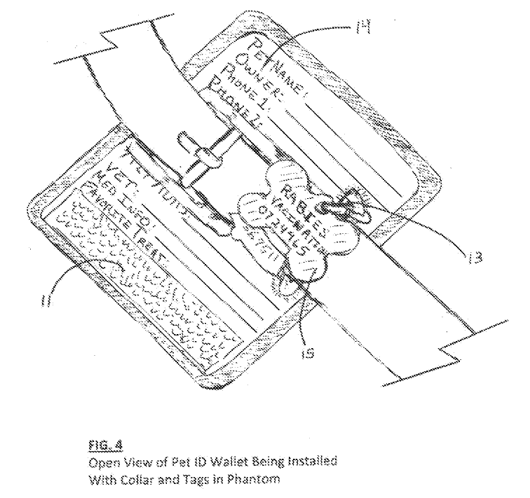

FIG. 2 the interior or inside of the pet information wallet has one of various attachment means including, but not limited to, hook and loop fastener, snaps, rivets, glue, buttons, etc., attached to one end 11. The interior or inside of the pet information wallet has space for a wealth of information about the pet, including but not limited to, pet name, owner name, multiple owner phone numbers, multiple owner addresses, the pet's veterinarian, the pet's medical information, favorite treat, etc. There is also the buttonhole type opening 13 to allow the permanently affixed metal “D” ring 27, which comes standard on pet collars, encapsulating the existing metal pet tags and licenses and still allows the attachment of a leash or lanyard while the pet wallet remains affixed to the pet's collar.

FIG. 3 Consists of the placard, nametag, etc., which has reflective properties. The pet's name is either printed or hand written with a writing device such as but not limited to a Permanent magic marker on this reflective material and then placed between the exterior or outside of the pet wallet 10 and the clear see-thru plastic sleeve 12 which is affixed to the exterior or outside of the pet information wallet and open on one end to allow the placard, name tag, etc., to be affixed to the pet wallet yet remain highly visible when the pet wallet is affixed to the pet.

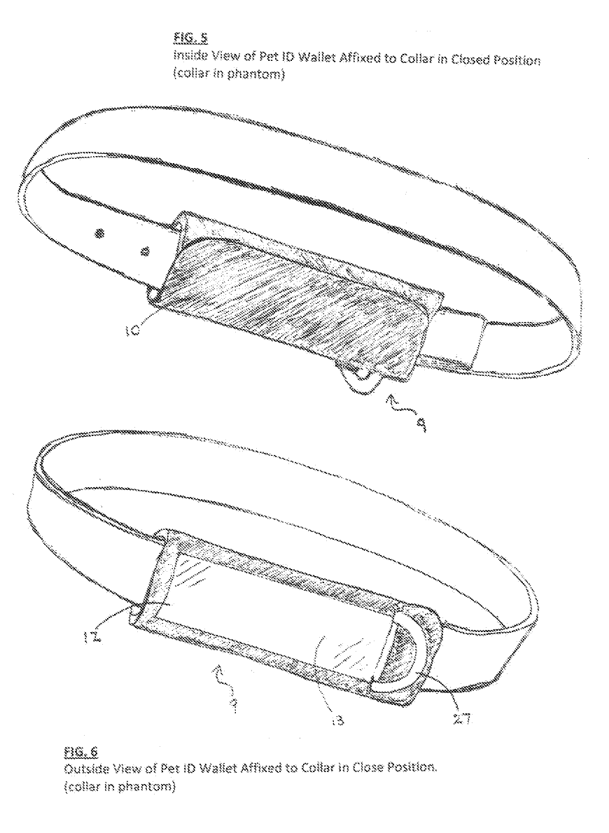

FIG. 4 Illustrates the pet information wallet in the open position with the metal “D” ring from the pet collar placed thru the buttonhole type opening 13. The pet's metal I.D. tags and licenses are placed on the back side of the collar 15 so that when the pet wallet is wrapped around the pet collar they are encapsulated inside the pet information wallet preventing them from being caught on objects such as, but not limited to, tree limbs, fences, etc., keeping them from falling off the collar and also stopping the chaffing and noise normally associated with the jingling that occurs from the met pet tags when the pet has movement. This process also keeps the metal “D” ring on the pet collar free to attach a leash or lanyard 27.

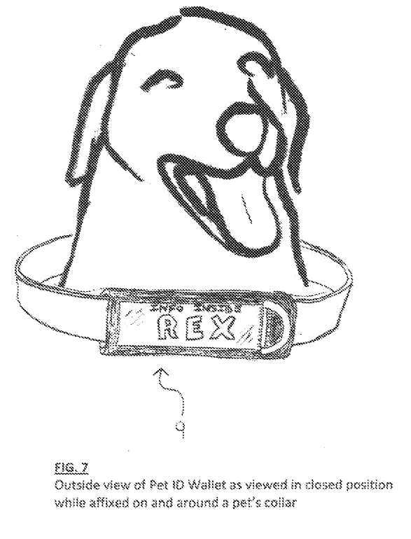

FIG. 5 Illustrates the pet information wallet in the closed or affixed position from the perspective of seeing inside the collar. The exterior or outside of the pet wallet 10 is the exposed and visible material when the pet wallet is in the closed or affixed position from this perspective.

FIG. 6 Illustrates the pet wallet in the closed or affixed position from the perspective of viewing the collar from the front, main, or primary position. The clear plastic see-thru sleeve 12 is highly visible and allows the viewing of the pet name tag, placard, etc., while in the closed position. The buttonhole type opening 13 has the pet collar metal “D” ring protruding thru the buttonhole type opening 13 allowing the attachment of a leash or lanyard while the pet wallet is affixed to the pet's collar. Additionally the metal pet I.D. tags and licenses are now encapsulated inside the wallet, alleviating their ability to rattle and make noise and fall off of the pet collar.

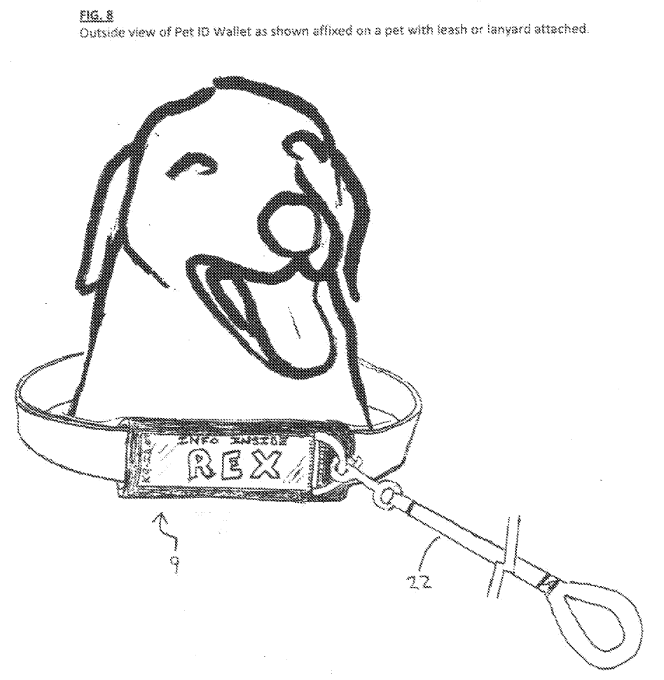

FIG. 7 Illustrates the pet information wallet installed or affixed on the pet collar with the placard or name tag installed inside the clear plastic sleeve 12 giving both ease of identification and nighttime safety via reflectivity. The pet collar metal “D” ring 27 is protruding and unencumbered to allow the attachment of a leash or lanyard. A dog is used to facilitate this example in phantom

FIG. 8 Illustrates the pet information wallet installed or affixed on the pet collar, shows the capability of a leash or lanyard type tethering device to be connected to the pet collar while the pet information wallet is attached and the metal pet I.D. tags and licenses are attached to the pet's collar yet are encapsulated inside the wallet.

What is claimed:

1. A pet information wallet comprised of (a) non rigid and or stretchable weather-resistant material that wraps around a pet's collar and affixes to and around the pet' collar. (b) An inner weather-resistant material allowing for a vast amount of printed information regarding the pet and it's owner, such as, but not limited to, multiple phone numbers, addresses, veterinarian and life critical medical information.

2. The pet information wallet has a buttonhole type opening to allow the pet collar metal “D” ring, used for leash attachment, to slide thru the pet information wallet when the pet information wallet is wrapped around or affixed to the pet collar, so that a leash or lanyard can be attached and removed from the collar without having to alter or remove the pet information wallet to attach or detach a leash or lanyard.

3. When the pet information wallet is wrapped around the collar the industry standard attached metal pet I.D. tags and licenses fit inside the wallet keeping them from falling off the pet collar.

4. Furthermore, by having the metal pet I.D. tags and licenses encapsulated inside the pet information wallet they are far less likely to be caught on an object, such as but not limited to, a limb, branch, stick, etc.

5. By having the pet information wallet wrapped around or affixed to the pet collar and having the pet I.D. tags and licenses encapsulated inside the pet information wallet, chaffing, which can render the tags unreadable, tarnish which can end up on the pets fur, and noise from rattling, which can awaken and or annoy humans are alleviated.

6. By having the metal pet I.D. tags and licenses encapsulated inside the pet information wallet, the pet will not have to listen to the jingling and noise caused by everyday pet movement.

7. The exterior of the wallet, which is visible when affixed to the pet collar, is of reflective material having the pet's name printed on the exterior, allowing the pet's name to be highly visible and provide night time safety.

8. The pet wallet of claim 1 (a) has an outer non rigid or stretchable weather-resistant, material having a hook and loop type fastener affixed to one end on the outside of the wallet and an additional hook and loop fastener at the opposite end on the inside of the pet wallet, allowing it to be wrapped around and or affixed to the pet collar so that it travels continuously with the pet.

9. A clear plastic sleeve is affixed to the outside of the exterior material allowing a nametag or placard to be slid inside the clear plastic making the pet's name highly visible.

10. By using reflective material for the above-mentioned placard or nametag, the reflectivity of the tape inside the clear sleeve serves an addition function of making the pet safer at night by reflecting light from oncoming vehicles and or other light sources.
